(19) United States
(12) Patent Application Publication
(10) Pub. No.: US 2023/0382936 A1
(43) Pub. Date: Nov. 30, 2023

(54) MANUFACTURING OF COVALENT ORGANIC FRAMEWORK-BASED OXYGEN CATALYST AND DEVELOPMENT OF METAL-AIR SECONDARY BATTERY

(71) Applicant: INDUSTRY-UNIVERSITY COOPERATION FOUNDATION HANYANG UNIVERSITY ERICA CAMPUS, Gyeonggi-do (KR)

(72) Inventors: Jong-Ho Kim, Gyeonggi-do (KR); Jung Hyun Park, Gyeonggi-do (KR); Jong-Min Ju, Gyeonggi-do (KR)

(21) Appl. No.: 18/032,332

(22) PCT Filed: Sep. 17, 2021
(86) PCT No.: PCT/KR2021/012769

§ 371 Date: Apr. 17, 2023

(30) Foreign Application Priority Data
Oct. 21, 2020 (KR) 10-2020-0137017
Oct. 21, 2020 (WO) PCT/KR2021/012769
Aug. 6, 2021 (KR) 10-2021-0103713

(51) Int. Cl. C07F 15/06; H01M 12/08

(52) U.S. Cl. CPC C07F 15/06; H01M 12/08

(57) ABSTRACT

The present disclosure relates to an electrocatalyst for a metal-air battery, which includes an organic framework coordinated with metal nanoparticles, a metal-air battery including the same, and a method manufacturing the same, wherein the organic framework in the electrocatalyst is formed by a substitution reaction of a first compound containing an amine group and a second compound containing a heterocycle substituted with a halogen group and has bifunctionality with catalytic activity for oxygen reduction reaction (ORR) and oxygen evolution reaction (OER).

### TECHNICAL FIELD

The present disclosure relates to a covalent organic framework-based electrocatalyst with dual activity for a metal-air battery and a method for manufacturing the same.

### BACKGROUND ART

An aqueous electrolyte battery is a promising technology for meeting the increasing demand on safe, non-explosive energy storage systems for wearable electronic products, mobile displays, medical devices and electric vehicles. In particular, a chargeable zinc-air battery is drawing more and more attentions as an aqueous energy storage system because of high energy density, superior durability, superior safety, low cost and environmental friendliness. The zinc-air battery is operated by reversible oxygen reduction reaction (ORR) and oxygen evolution reaction (OER) at a negative electrode during charging and discharging in an aqueous alkaline electrolyte. But, an effective electrocatalyst is necessary for facilitating the reactions because the ORR and OER of the zinc-air battery proceed at very slow rates due to high overvoltage. Noble metal electrocatalysts such as Pt/C, IrO₂ and RuO₂ have been used widely to facilitate ORR and OER owing to their superior catalytic activity. However, the noble metal electrocatalysts have a few inherent limitations including monofunctional activity for ORR or OER, poor durability, high cost and low abundance.

In order to overcome the limitations of the noble metal electrocatalysts, heteroatom-doped or non-noble metal-bound carbon electrocatalysts are being researched actively as electrocatalysts with dual activity for effective facilitation of ORR and OER at the air negative electrode of the zinc-air battery. In many previous researches, it was found out that the bifunctional electrocatalytic activity of carbon nanomaterials for ORR and OER depend greatly on chemical and physical structures including metal-N-C active sites, N-doping, pore size and surface area. Accordingly, it is very important to fine-tune the structure of the carbon electrocatalysts in a controllable manner for superior activity. However, the precise control of active sites and electronic structure remains as a big challenge for most of the currently developed carbon electrocatalysts. Therefore, a simple and controllable strategy is necessary for reasonable design of a bifunctional carbon electrocatalyst having activity for both ORR and OER for use in a rechargeable zinc-air battery.

COFs (covalent organic frameworks) are a new class of crystalline carbon materials formed from the covalent bonding of many organic building blocks. The chemical and physical structure of the COF may be controlled precisely by changing the organic building blocks and the type of linkages and shapes thereof during synthesis. In addition, heteroatoms (B, N, O or S) distributed uniformly as distinct pores in the COF are useful for application as catalysts. When considering the excellent functionality in terms of precise control of structure, the COF is expected to be a good candidate for reasonable design of a bifunctional carbon electrocatalyst for facilitating both ORR and OER in a zinc-air battery, and some COF-based electrocatalysts have been reported actually. However, the catalysts facilitated merely one of ORR and OER, and did not exhibit bifunctional electrocatalytic activity. At present, there are few bifunctional COF electrocatalysts that can facilitate both ORR and OER in a zinc-air battery. Accordingly, the designing of a bifunctional COF electrocatalyst through controlling of electronic structure is important for facilitating reversible oxygen redox reaction at the liquid-solid interface of a zinc-air battery.

### DISCLOSURE OF THE INVENTION

### Technical Problem

The present disclosure is directed to providing a covalent organic framework-based electrocatalyst with dual activity for an air battery and a method for manufacturing the electrocatalyst.

The present disclosure is also directed to providing a manufacturing the electrocatalyst with dual activity.

The technical problems to be solved by the present disclosure are not limited to those described above, and other problems not mentioned above may be clearly understood by those having ordinary knowledge in the art from the following description.

### Technical Solution

The present disclosure provides an electrocatalyst for a metal-air battery including an organic framework coordinated with metal nanoparticles, wherein the organic framework is formed by a substitution reaction of a first compound containing an amine group and a second compound containing a heterocycle substituted with a halogen group.

In an exemplary embodiment of the present disclosure, the substitution reaction may be a nucleophilic substitution reaction of the hydrogen of the amine group of the first compound and the halogen group of the second compound and, as a result, the first compound and the second compound may be repeated in the organic framework.

In an exemplary embodiment of the present disclosure, the metal nanoparticles may be one or more selected from a group consisting of cobalt nanoparticles, iron nanoparticles, nickel nanoparticles and manganese nanoparticles.

In another exemplary embodiment of the present disclosure, the first compound may be one or more selected from a group consisting of 2,6-diaminopyridine, 2,5-diaminopyridine, imidazole, 2-methylimidazole, ethylenediamine and phenylenediamine.

In another exemplary embodiment of the present disclosure, the halogen group may be one or more selected from a group consisting of chloride, bromide and iodide.

In another exemplary embodiment of the present disclosure, the heterocycle may be one or more selected from a group consisting of triazine, pyridine and pyrimidine.

In another exemplary embodiment of the present disclosure, the second compound may be cyanuric chloride.

In another exemplary embodiment of the present disclosure, the framework may have a triangular form comprising pores of 0.5-20 nm and may have a surface area of 100-500 m²/g.

In another exemplary embodiment of the present disclosure, the framework may have a structure of Chemical Formula 1.

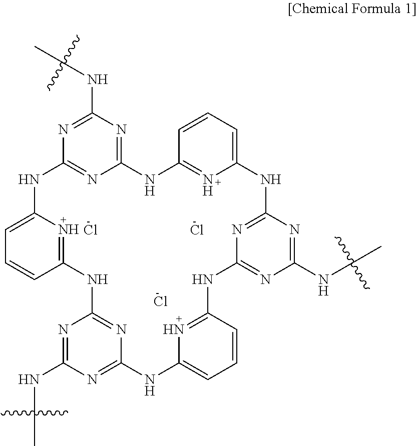 [SMILES: *Nc1nc2nc(n1)[nH]c1cccc(n1)[nH]c1nc(N*)nc(n1)[nH]c1cccc(n1)[nH]c1nc(N*)nc(n1)[nH]c1cccc(n1)[nH]2 ; Cl ; Cl ; Cl]

In another exemplary embodiment of the present disclosure, the electrocatalyst may have catalytic activity for oxygen reduction reaction (ORR) and oxygen evolution reaction (OER).

In another exemplary embodiment of the present disclosure, the metal-air battery may be a zinc-air battery.

The present disclosure also provides a metal-air battery including the electrocatalyst.

The present disclosure also provides a method for preparing an electrocatalyst for a metal-air battery, which includes: a step of preparing an organic framework by a substitution reaction of a first compound containing an amine group and a second compound containing a heterocycle substituted with a halogen group (S1); and a step of reacting the organic framework with a metal precursor (S2).

In an exemplary embodiment of the present disclosure, the substitution reaction may be a nucleophilic substitution reaction of the hydrogen of the amine group of the first compound and the halogen group of the second compound and, as a result, the first compound and the second compound may be repeated in the organic framework.

In another exemplary embodiment of the present disclosure, the metal precursor may be one or more selected from a group consisting of cobalt nitrate, cobalt sulfate, cobalt phosphate, cobalt tetrafluoroborate and cobalt chloride.

In another exemplary embodiment of the present disclosure, in the step S1, the first compound and the second compound may be mixed and reacted at 60-120° C. for 12-36 hours under stirring.

In another exemplary embodiment of the present disclosure, in the step S2, the organic framework and the metal precursor may be mixed and reacted at 120-180° C. for 2-8 hours under stirring.

### Advantageous Effects

An electrocatalyst including an organic framework of the present disclosure has excellent stability and exhibits low overvoltage for both ORR and OER.

Since a metal-air battery including the organic framework has been confirmed to have a small voltage gap of 0.83 V and superior durability for 720 cycles as compared to the existing battery including commercial Pt/C & RuO₂, the organic framework can be usefully used for preparation of various carbon electrocatalysts.

### BRIEF DESCRIPTION OF THE DRAWINGS

FIG. 1 schematically illustrates the synthesis of a pyridine-linked triazine covalent organic framework (PTCOF) and a cobalt nanoparticle-embedded PTCOF oxygen electrocatalyst (CoNP-PTCOF) according to an exemplary embodiment of the present disclosure.

FIG. 2 shows a result of structural analysis of an ionic PTCOF. a) TEM, b) HR-TEM (insert: SAED mode) and c) elemental mapping images of PTCOF. d) Solid-state ¹³C-NMR and e) FT-IR spectra of PTCOF. f) Pore size distribution of PTCOF obtained using the NL-DFT model. g) Powder XRD pattern of PTCOF (insert: magnified pattern from 15° to) 37°). h) Top and side views of the AA-stacked PTCOF.

FIG. 3 shows the FT-IR spectra of cyanuric chloride (black) and 2,6-diaminopyridine (red).

FIG. 4 shows the XPS spectra of a) C 1s, b) N 1s, c) O 1s, d) Co 2p, e) Cl 2p and f) PTCOF.

FIG. 5 shows the N₂ adsorption-desorption isotherms of PTCOF.

FIG. 6 shows a) N₂ adsorption-desorption isotherm and b) pore size distribution of PTCOF obtained using the NL-DFT model after removing HCl by heat-treating at 800° C.

FIG. 7 schematically shows the growth of PTCOF in triangular form.

FIG. 8 shows a) TEM image and b) dark-field image of Co(NO₃)₂-coordinated PTCOF, and the elemental mapping images for c) carbon d) nitrogen, e) cobalt and f) chlorine atoms of Co(NO₃)₂-coordinated PTCOF.

FIG. 9 shows a result of structural analysis of a CoNP-PTCOF electrocatalyst. a) TEM, b) HR-TEM (insert: SAED mode) and c) elemental mapping images of CoNP-PTCOF. d) Powder XRD pattern of CoNP-PTCOF. e) N₂ adsorption-desorption isotherm. f) Pore size distribution of CoNP-PTCOF calculated by the NL-DFT method.

FIG. 10 shows the powder XRD pattern of CoNP-PTCOF.

FIG. 11 shows the FT-IR spectrum of Co(NO₃)₂-coordinated PTCOF.

FIG. 12 shows the chemical and electronic structures of a CoNP-PTCOF electrocatalyst. a) C 1s, b) N is and c) Co 2p XPS spectra of CoNP-PTCOF.

FIG. 13 shows a) O 1s, b) Cl 2p and c) full XPS spectra of CoNP-PTCOF.

FIG. 14 shows a) C 1s, b) N 1s, c) O 1s, d) Co 2p, e) Cl 2p and f) full XPS spectra of Co(NO₃)₂-coordinated PTCOF.

FIG. 15 shows a result of investigating the electrocatalytic activity of CoNP-PTCOF for ORR and OER. a) LSV curves of PTCOF, CoNP-PTCOF and Pt/C for ORR in O₂-saturated KOH solution (0.1 M) at 1600 rpm, b) number of electrons and yield of peroxide for CoNP-PTCOF and Pt/C for ORR, c) LSV curves of PTCOF, CoNP-PTCOF and RuO₂ for OER in O₂-saturated KOH solution (0.1 M) at 1600 rpm, d) Tafel plots of electrocatalysts used in ORR and OER, e) polarization curves of PTCOF, CoNP-PTCOF and mixture of Pt/C and RuO₂ for ORR and OER in O₂-saturated KOH solution, and f) current vs. time measurement result for CoNP-PTCOF and Pt/C & RuO₂ for continuous ORR and OER at 0.6 V and 1.7 V (vs. RHE), respectively (insert: reversibility of catalysts for ORR and OER, ΔE=Eⱼ₁₀−E_{1/2}).

FIG. 16 shows a current vs. time measurement result for CoNP-PTCOF and Pt/C & RuO₂ for a) ORR and b) OER at 0.6 and 1.7V (vs. RHE), respectively.

FIG. 17 shows a result of investigating the performance of a rechargeable zinc-air battery assembled with CoNP-PTCOF. a) Schematic view of zinc-air battery assembled with CoNP-PTCOF, b) LSV curves and power density plots for charging and discharging of zinc-air battery assembled with CoNP-PTCOF and Pt/C & RuO₂-based battery, c) specific capacity at current density of 10 mA cm⁻², and charge-discharge profile of d) zinc-air battery assembled with CoNP-PTCOF and e) Pt/C & RuO₂-based battery.

### BEST MODE FOR CARRYING OUT THE INVENTION

The inventors of the present disclosure have made researched consistently to prepare an electrocatalyst for a metal-air battery having bifunctionality for ORR and OER, and have completed the present disclosure.

That is to say, the present disclosure provides an electrocatalyst for a metal-air battery, which includes an organic framework coordinated with metal nanoparticles, wherein the organic framework is formed by a substitution reaction of a first compound containing an amine group and a second compound containing a heterocycle substituted with a halogen group.

The present disclosure also provides a method for manufacturing a metal-air battery including the electrocatalyst.

The present disclosure also provides a method for preparing an electrocatalyst for a metal-air battery, which includes: a step of preparing an organic framework by a substitution reaction of a first compound containing an amine group and a second compound containing a heterocycle substituted with a halogen group (S1); and a step of reacting the organic framework with a metal precursor (S2).

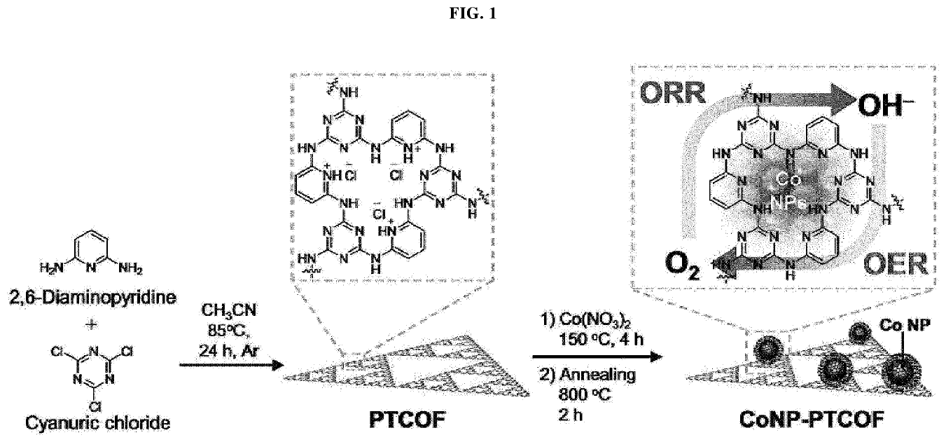

FIG. 1 shows a method for preparing an organic framework according to an exemplary embodiment of the present disclosure. In the present disclosure, the organic framework is a covalent organic framework having covalent bonds, and is in the form of a 2D or 3D organic solid. The organic framework may have an extended structure generated by covalent bonding of organic blocks, and may have a porous crystal structure. In the present disclosure, the organic framework may be coordinated with metal nanoparticles.

The organic framework may have a triangular form including pores of 0.5-20 nm with layered stacks, and may be utilized as an electrocatalyst with superior performance because it has a surface area of 100-500 m²/g. The framework prepared according to the present disclosure may facilitate the migration of ions at the solid-liquid interface because it has lower crystallinity as compared to imine-based COFs.

In the present disclosure, the metal nanoparticles may be one or more selected from a group consisting of cobalt nanoparticles, iron nanoparticles, nickel nanoparticles and manganese nanoparticles. Specifically, cobalt nanoparticles may be used. The cobalt nanoparticles may be coordinated in the framework and may be dispersed uniformly without aggregation. Through this, the metal nanoparticles may increase catalytic activity by increasing the surface area of the framework and increasing the electron density of the carbon backbone.

In another exemplary embodiment of the present disclosure, the first compound may be any compound containing an amine group without limitation. Specifically, it may be one or more selected from a group consisting of 2,6-diaminopyridine, 2,5-diaminopyridine, imidazole, 2-methylimidazole, ethylenediamine and phenylenediamine, although not being limited thereto.

In the second compound, the halogen group may be one or more selected from a group consisting of chloride, bromide and iodide, and the heterocycle may be one or more selected from a group consisting of triazine, pyridine and pyrimidine. Specifically, the second compound may be cyanuric chloride.

The framework of the present disclosure may have a form wherein pyridine-amine-triazine blocks are repeated through a nucleophilic substitution reaction of the hydrogen of the amine group of the first compound and the halogen group of the second compound. Specifically, the framework may have a structure of Chemical Formula 1:

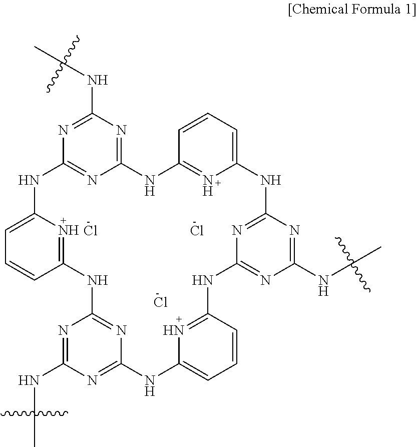 [SMILES: *Nc1nc2nc(n1)[nH]c1cccc(n1)[nH]c1nc(N*)nc(n1)[nH]c1cccc(n1)[nH]c1nc(N*)nc(n1)[nH]c1cccc(n1)[nH]2 ; Cl ; Cl ; Cl]

The metal-air battery of the present disclosure may be a zinc-air battery.

The battery may have a structure including: an air electrode including the electrocatalyst; a negative electrode; a separator; and an electrolyte, and may further include a case for casing the battery. The components described above may be prepared from materials commonly used for the manufacturing of an air battery.

In addition, the present disclosure provides a method for preparing an electrocatalyst for a metal-air battery, which includes the steps S1 and S2.

In the step S2, the metal precursor used for coordination of the metal nanoparticles may be one or more selected from a group consisting of cobalt nitrate, cobalt sulfate, cobalt phosphate, cobalt tetrafluoroborate and cobalt chloride.

In another exemplary embodiment of the present disclosure, in the step S1, the first compound and the second compound may be mixed and reacted at 60-120° C. for 12-36 hours under stirring, although not being limited thereto.

In another exemplary embodiment of the present disclosure, in the step S2, the organic framework and the metal precursor may be mixed and reacted at 120-180° C. for 2-8 hours under stirring, although not being limited thereto.

In an example of the present disclosure, a pyridine-linked triazine covalent organic framework (PTCOF) with well-defined active sites and pores was synthesized easily by a nucleophilic substitution reaction of cyanuric chloride and 2,6-diaminopyridine under a mild condition. The electronic structure of PTCOF was tuned by incorporating Co nanoparticles (denoted as CoNP-PTCOF) to induce bifunctional electrocatalytic activity for both ORR and OER, since cobalt is a widely used transition metal for oxygen electrocatalysts and incorporating it into a carbon structure can enhance the electrocatalytic activity for ORR and OER. The electrocatalytic activity of the pyridine-rich CoNP-PTCOF for oxygen redox reaction was verified thoroughly. Furthermore, computer simulation was performed to gain insight into the electronic structures of PTCOF and CoNP-PTCOF and the catalytically active sites of pyridine carbon for ORR and OER under alkaline conditions. Finally, a zinc-air battery was fabricated using the bifunctional CoNP-PTCOF. The battery exhibited superior performance as compared to a battery with a mixture of monofunctional Pt/C and RuO₂.

Hereinafter, the covalent organic framework-based oxygen catalyst and the metal-air secondary battery including the same according to the present disclosure will be described referring to a specific example. However, the following example is provided only as a specific example of the present disclosure and it should not be understood as limiting the present disclosure.

### EXAMPLE

### Preparation and Analysis

### 1. Materials

All chemicals were used without further purification. Cobalt nitrate, cyanuric chloride, Nafion solution (5 wt %) and RuO₂ nanoparticles were purchased from Sigma-Aldrich (USA). Acetonitrile and potassium hydroxide were purchased from Daejung Chemicals (Korea), and 2,6-diaminopyridine and zinc acetate dihydrate were purchased from Tokyo Chemical Industry (Japan) and Alfa Aesar (USA), respectively. Ketjen black and 60 wt % PTFE solution were purchased from Mitsubishi Chemical (Japan) and Shanghai Aladdin Biochemical Technology (China), respectively, and carbon cloth was purchased from Cetech (Taiwan).

### 2. Instruments

The morphology and elemental distribution of PTCOF and CoNP-PTCOF were investigated by transmission electron microscopy (TEM, JEM-2100F, JEOL, Japan), and crystallinity was investigated using a high-power X-ray diffractometer (XRD, X′Pert-PRO MPD, Malvern Panalytical, UK) together with Cu Kα radiation (λ=1.5406 Å). Nitrogen adsorption-desorption isotherms were obtained at 77 K (Micromeritics, 3Flex, USA). Surface area and pore size distribution were determined from adsorption desorption branching of by the Brunauer-Emmett-Teller (BET) and non-local density functional theory (NL-DFT) methods. The quantity of cobalt in the catalysts was quantified by inductively coupled plasma atomic emission spectroscopy (ICP-AES, Spectro, Spectro Arcos, USA). The chemical composition of the catalysts was confirmed by X-ray photoelectron spectroscopy (XPS, AXIS-His, Kratos, UK), 400-MHz solid NMR spectroscopy (Avance III HD, Bruker, Germany) and Fourier-transform infrared spectroscopy (FT-IR, Nicolet iS10, Thermo Scientific). Thermal stability was analyzed using a thermogravimetric analyzer (SDT Q600, TA Instruments, USA). Electrocatalytic activity and charge-discharge performance were measured using a potentiostat/galvanostat (VersaSTAT3, Princeton Applied Research, USA) and a battery cycler (WBCS3000, WonATech, Korea).

### 3. Preparation of PTCOF

After adding 1.47 g of cyanuric chloride in a three-necked round-bottom flask (100 mL) connected to a condenser, the flask was purged at room temperature for 15 minutes with Ar gas. Then, 25 mL of anhydrous acetonitrile was added to the flask as a solvent under Ar atmosphere. After adding 1.3 g of 2,6-diaminopyridine in 15 mL of anhydrous acetonitrile, it was slowly added to the cyanuric chloride solution at room temperature for 10 minutes. After stirring the reaction mixture at room temperature for 1 hour, reaction was carried out at 85° C. for 24 hours. After filtering the product using a 0.1-μm PVDF membrane filter (Durapore®, Merck, Germany), it was washed several times with acetonitrile and acetone. The product, i.e., PTCOF, was dried overnight in vacuo.

### 4. Preparation of CoNP-PTCOF

30 mL of acetonitrile was added to 98 mg of cobalt nitrate (Co(NO₃)₂.6H₂O, 20 wt %) and 100 mg of PTCOF in a Teflon-lined stainless steel autoclave. After stirring the reaction mixture in the autoclave at 150° C. for 4 hours, the cobalt-coordinated PTCOF was filtered and washed several times with acetone and acetonitrile. After drying the cobalt-coordinated PTCOF overnight in vacuo, CoNP-PTCOF was obtained by annealing the same at 800° C. for 2 hours under Ar atmosphere at a rate of 10° C./min.

### 5. General Procedure for Electrochemical Measurement of ORR and OER

All electrochemical measurements were performed using a potentiostat equipped with a typical three-electrode system, including a glassy carbon rotating disk electrode (RDE, 5 mm in diameter) as a working electrode, a Pt wire counter electrode and a Hg/HgO (20 wt % KOH) reference electrode, in an O₂-saturated 0.1 M KOH solution at room temperature. The potentials of the reference electrode was calibrated based on H₂ evolution and oxidation reactions, which were referenced to a reversible hydrogen electrode (RHE) using the well-known Equation 1.

E_{RHE}=E_{Hg/HgO}+0.21+0.059×pH [Equation 1]

In Equation 1, E_{RHE} is the converted potential vs. RHE, and E_{Hg/HgO} is the potential of the Hg/HgO reference electrode.

A catalytic ink was prepared by dispersing 2 mg of each catalyst in a mixture solution containing 15 μL of Nafion solution and 485 μL of ethanol through sonication for 10 minutes. Then, 30 μL of the catalytic ink was dropped onto the glassy carbon electrode (RDE) to a mass load of 0.61 mg cm⁻². For comparison, Pt/C & RuO₂ ink was prepared using the same procedure.

For ORR and OER measurements, linear sweep voltammetry (LSV) was conducted at a scan rate of 5 mV s⁻¹ using an RDE rotating at a speed of 1,600 rpm in an O₂-saturated 0.1 M KOH solution.

### 6. Measurement of Number of Transferred Electrons and H₂O₂ Yield For ORR

A catalytic ink was prepared by dispersing 2 mg of the catalyst in a mixture solution containing 15 μL of Nafion solution and 485 μL of ethanol through sonication for 10 minutes. Then, 30 μL of the catalytic ink was dropped onto the glassy carbon electrode (RDE) to a mass load of 0.61 mg cm⁻². For comparison, Pt/C ink was also prepared using the same procedure. Rotating ring-disk electrode (RRDE) measurement was conducted for all the catalysts. The RRDE consisted of a glassy carbon disk with a diameter of 5.61 mm and a concentric Pt ring with a length of 318 μm, a diameter of 7.92 mm and a current collection efficiency was 0.37. The scan rate of RRDE was 5 mV s⁻¹ and the ring potential was maintained constant at 1.3 V vs. RHE.

The number of transferred electrons (n) and H₂O₂ yield during ORR was calculated by Equations 2 and 3.

$$[ Equation 2 ]$$

$$n = 4 \frac{{I}_{d}}{{I}_{d} + {I}_{r} / N} \qquad ( S2 )$$

$$[ Equation 3 ]$$

$${H}_{2} {O}_{2} = 100 \frac{2 {I}_{r} / N}{{I}_{d} + {I}_{r} / N} \qquad ( S3 )$$

In Equations 2 and 3, I_{d} is the disk current, Iᵣ is the ring current, and N is the current collection efficiency of the Pt ring.

### 7. Test for Rechargeable Zinc-Air Battery

The aqueous zinc-air batteries were tested using a home-built battery test cell. A catalytic ink was prepared by dispersing 2 mg of the catalyst in 485 μL of ethanol containing Ketjen black (0.2 mg), Nafion (5 wt %, 15 μL) and PTFE (60 wt %, 2 μL) through sonication for 10 minutes. Then, 480 μL of the catalytic ink was dropped onto a carbon paper with a diameter of 2 cm. The carbon paper was completely dried at 80° C. for 30 minutes before it was used as an air negative electrode. The final mass load of the catalyst was 0.61 mg cm⁻². For comparison, Pt/C & RuO₂ ink was prepared in the same way and then dropped onto a carbon paper.

A Zn plate and a solution mixture of 6 M KOH and 0.2 M Zn(OAc)₂ were used as a positive electrode and an electrolyte, respectively, to fabricate a rechargeable zinc-air battery. The fabricated zinc-air battery was assessed using air as an oxygen source provided by an air pump connected to the air negative electrode. The charge-discharge profile was recorded using a multichannel battery test system. The period of each charge-discharge cycle was 10 minutes, with a 2-second rest time per cycle.

### Result

1. Synthesis of PTCOF with Well-Defined Structure and Pores

Pyridine and its derivatives have polar and conjugated bonds and have the ability to coordinate with various metal ions to form complexes, resulting in excellent electrocatalytic activity. Pyridine-rich PTCOF (with micropores and mesopores) was prepared easily by the nucleophilic substitution reaction of cyanuric chloride and 2,6-diaminopyridine in acetonitrile (FIG. 1). The filtration-based PTCOF processing procedure was very simple and its yield was very high (92%).

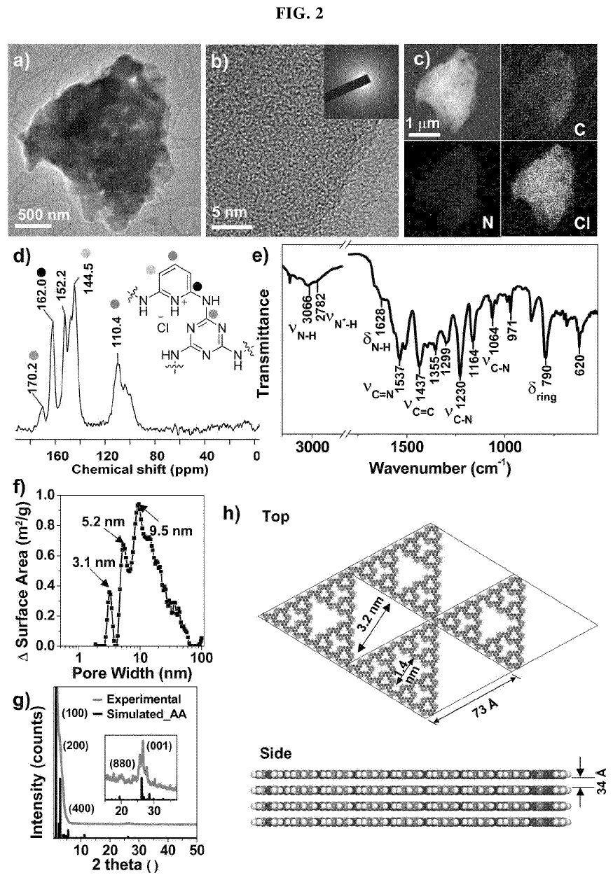

The structure of the prepared PTCOF was characterized by various spectroscopic methods. As can be seen from the transmission electron microscopy (TEM) images (FIGS. 2a and 2b), the PTCOF had a triangular form with layered stacks. The PTCOF exhibits relatively low crystallinity as compared to imine-based COFs. It is reported that amorphous or low-crystalline carbon structures are beneficial for facile ion migration and mass transport at solid-liquid interfaces. As shown in the energy-dispersive X-ray spectroscopy (EDX) image (FIG. 2c), nitrogen atoms are uniformly dispersed on the carbon backbone of PTCOF. In addition, chlorine atoms are found in the entire region of PTCOF because the pyridyl group is protonated to form pyridinium chloride during the synthesis reaction.

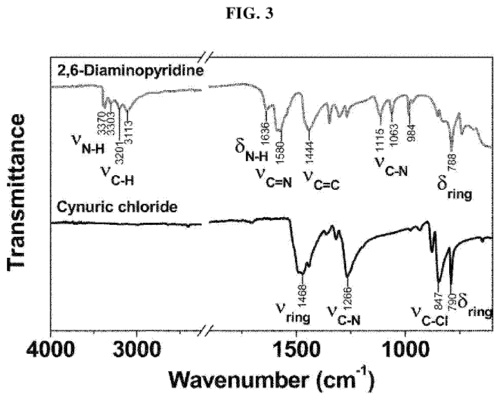

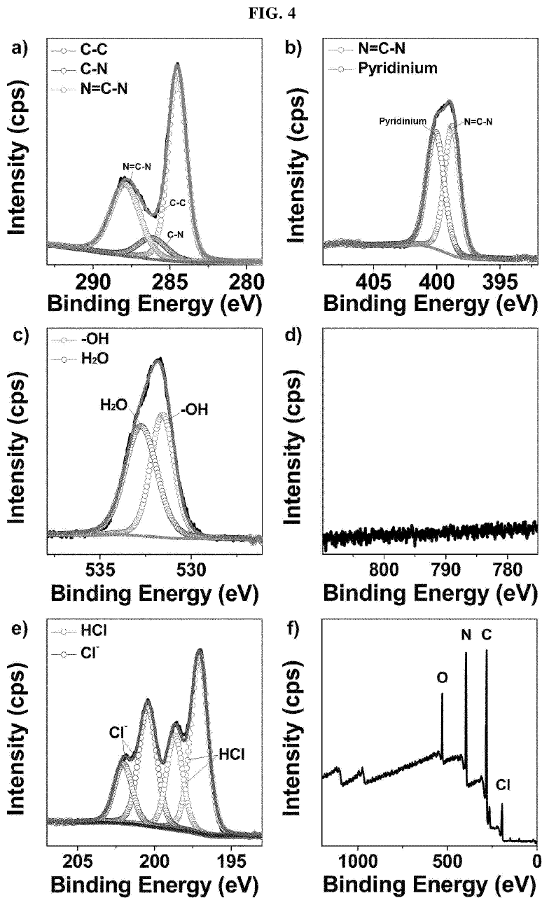

The ¹³ C-NMR spectrum of PTCOF clearly shows the characteristic peaks of C atoms of pyridinium and triazine at 110.4, 144.5, 162.0 and 170.2 ppm, respectively (FIG. 2d), while the C—Cl bond peak of cyanuric chloride at 172 ppm disappeared in the spectrum. In addition, characteristic vibrational modes of pyridinium and triazine groups, such as C═N (1537 cm⁻¹), C═C (1437 cm⁻¹), C—N (1064 cm⁻¹), N—H stretching (3066 cm⁻¹), N−H bending (1628 cm⁻¹) and NtH stretching (2782 cm⁻¹), appeared in the Fourier-transform infrared (FT-IR) spectrum of PTCOF, while the peak associated with the C—Cl bond of cyanuric chloride at 847 cm⁻¹ disappeared clearly (FIG. 1e and FIG. 3). The chemical structure of PTCOF was further confirmed by X-ray photoelectron spectroscopy (XPS). In the C 1 s XPS spectrum of PTCOF, the peaks for the C—N bond of pyridinium and the N═C—N bond of triazine appeared at 286.2 and 287.9 eV, respectively (FIG. 4). In addition, pyridinium N (400.1 eV) and N═C—N (398.8 eV) as well as chlorine (202.0, 200.4, 198.7 and 197.1 eV) were observed clearly in the N 1 s and Cl 2 p spectra of PTCOF. The content of chlorine atoms in PTCOF was measured by ion chromatography to be 12.6 wt %, almost the same as the theoretical amount (14.8 wt %). These results demonstrate that pyridine-rich PTCOF was synthesized successfully in a simple manner.

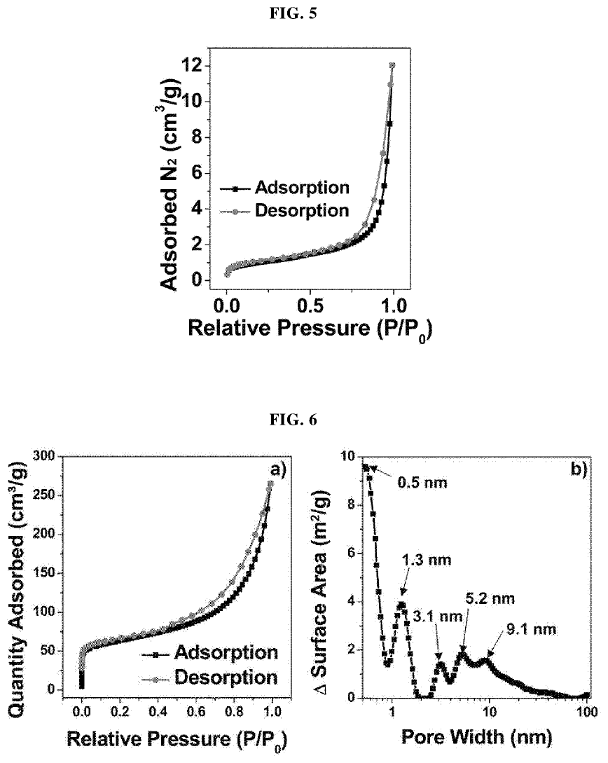

The pore size of the PTCOF was measured by Brunauer-Emmett-Teller (BET) analysis. The PTCOF showed a type IV isotherm with a mixed H₁-H₃ mixed hysteresis loop (FIG. 5), corresponding to the layered stacking shown in the TEM image. As shown in FIG. 2f, the PTCOF had mesopores of 3.1, 5.2 and 9.5 nm with a surface area of 55.59 m² g⁻¹. Micropores smaller than 2 nm were not observed in the pore distribution of the PTCOF because the large amount of counter anions (Cl⁻) in the protonated PTCOF (pyridinium chloride) might block the micropores. As expected, micropores appeared clearly in the BET pore distribution after removal of HCl from protonated PTCOF by annealing (FIG. 6). Mesopores can facilitate mass transport at the liquid-solid interface, while micropores facilitate easy electron transfer during ORR and OER.

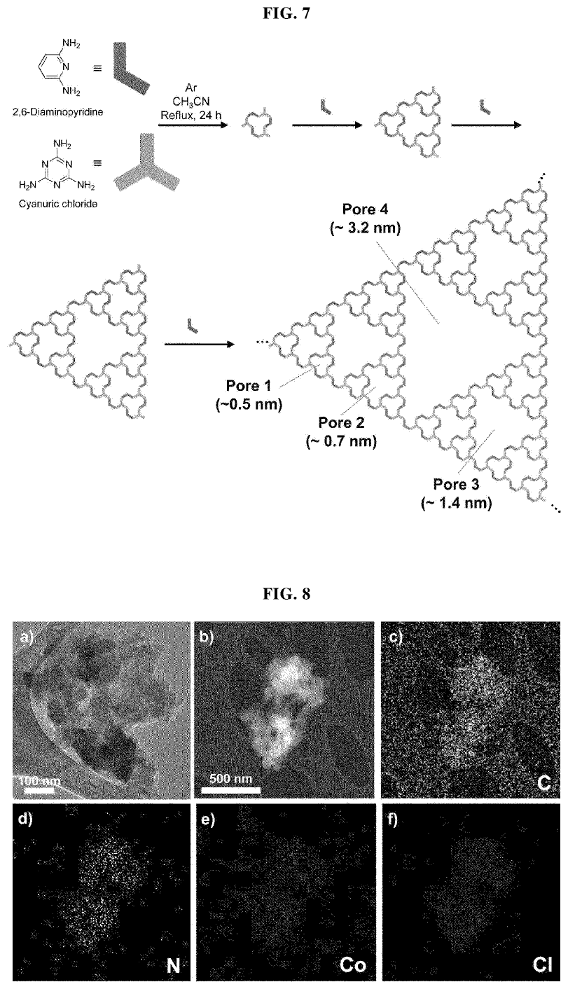

The crystal structure of PTCOF was further confirmed by X-ray diffraction (XRD) as well as Pawley refinement (FIG. 2g). In the XRD pattern of PTCOF, a broad diffraction peak was observed at ˜5°, corresponding to the (100), (200) and (400) planes. Furthermore, the (880) and (001) facets appeared clearly at 19.8° and 26.5°, indicating that the interlayer spacing in the layered stack structure of PTCOF is 3.4 Å. The XRD pattern is in good agreement with the pattern obtained by simulation (black line). Based on the XRD pattern, the PTCOF had a triangular periodic cell with a dim AA stack (FIG. 2h and FIG. 7). The corresponding micropores and mesopores were observed clearly in the BET analysis. That is to say, referring to FIG. 7, it can be seen that, in the compound according to an exemplary embodiment of the present disclosure, three pairs of compounds (three first and second compounds, respectively) having two functional groups capable of nucleophilic substitution reaction form one ring structure.

2. Synthesis of CoNP-Introduced PTCOF

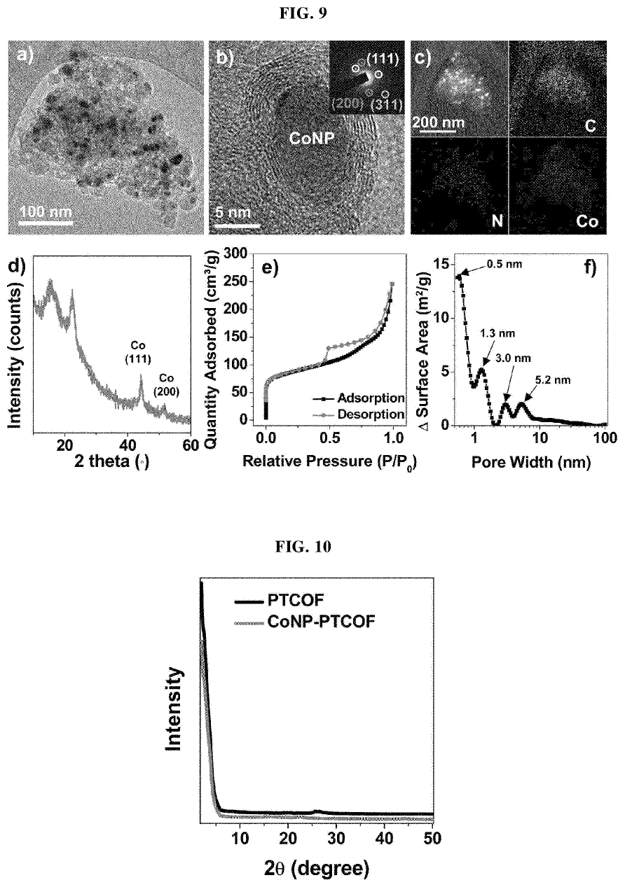

The electronic structure of PTCOF was tuned by incorporating Co nanoparticles (NPs) within the framework to induce bifunctional electrocatalytic activity for ORR and OER. After the introduction of Co(NO₃)₂ into PTCOF, Co atoms were dispersed uniformly throughout the framework (FIG. 8). The Co-coordinated PTCOF was annealed at 800° C. for 2 hours under Ar atmosphere to form CoNP-PTCOF. As shown in FIGS. 9a and 9b, CoNPs with an average size of 12.1 nm were embedded in the framework without aggregation. The selected area electron diffraction (SAED) pattern of CoNP-PTCOF revealed the formation of crystalline CoNPs. CoNPs of CoNP-PTCOF with N and C atoms were observed clearly from the dark-field image and EDX mapping data.

The CoNP-PTCOF was further characterized by XRD. The peaks of the (111) and (200) facets of CoNPs appeared at 44.2° and 51.6° (FIG. 9d), which are in good agreement with the SAED pattern. The XRD pattern of CoNP-PTCOF was almost identical to that of pristine PTCOF, except for the new peaks of CoNPs and the small peak shift of interlayer spacing (FIG. 10), indicating that upon incorporation of CoNPs, the interlayer spacing of the framework changed from 0.34 to 0.397 nm)(22.4°). The surface area and pore size of CoNP-PTCOF were measured by BET analysis. As shown in FIG. 9e, CoNP-PTCOF exhibited the type IV isotherm with a distinct H₃-type hysteresis loop and increased surface area (309.96 m²g⁻¹) as compared to pristine PTCOF (55.59 m²g⁻¹).This increased surface area can be attributed to the removal of HCl from the pyridinium chloride moiety of the PTCOF during annealing, leading to the appearance of inherent micropores as well as the formation of other pores. Micropores (0.5 and 1.3 nm) of the framework were observed in CoNP-PTCOF (FIG. 9f), which were almost identical to those of annealed PTCOF (FIG. 6). These results suggest that the framework structure was preserved well in CoNP-PTCOF.

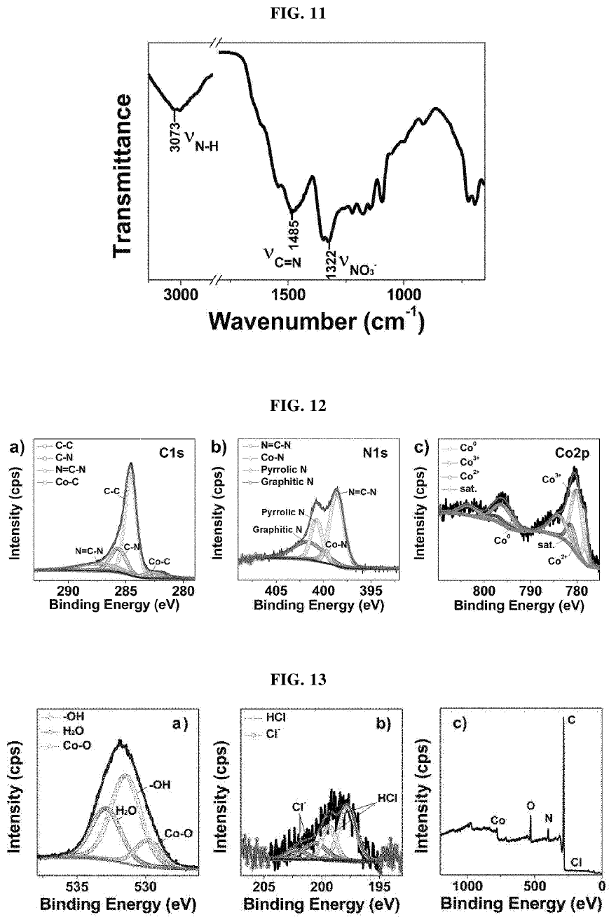

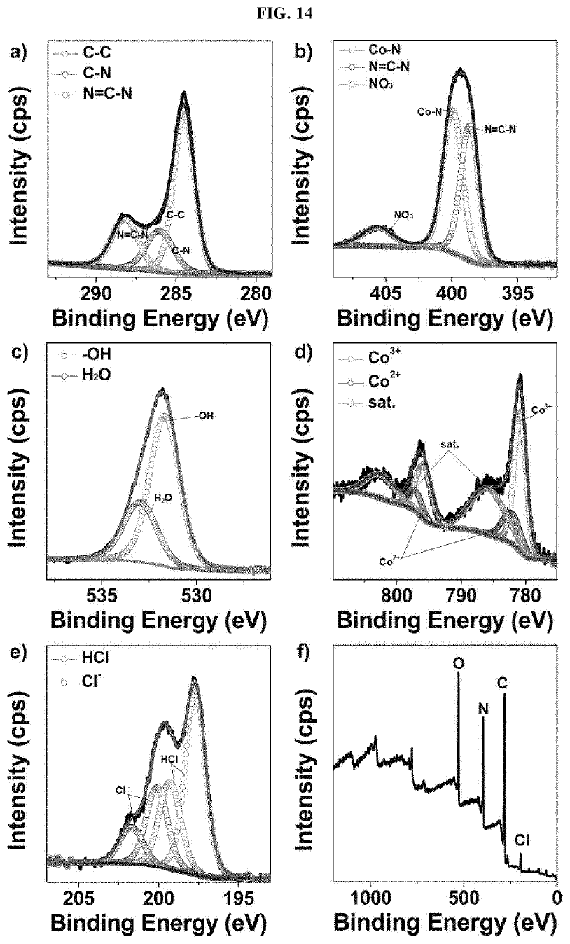

The chemical structure of CoNP-PTCOF was identified by FT-IR spectroscopy and XPS. After cobalt nitrate was coordinated in PTCOF, the vibrational mode of nitrate anion appeared at 1322 cm⁻¹ in the FT-IR spectrum, while the stretching mode of the N⁺-H bond in the pyridinium moiety of PTCOF at 2782 cm⁻¹ disappeared (FIG. 11). Furthermore, the peak of the C═N vibrational mode shifted from 1537 cm⁻¹ to a lower frequency (1485 cm⁻¹) in the spectrum, indicating that Co ions were bound to the pyridine and triazine moieties of PTCOF. The coupling of CoNPs with the pyridine and triazine groups of PTCOF was also observed in the XPS spectrum of CoNP-PTCOF. In the C 1 s XPS spectrum of CoNP-PTCOF, the binding energies of C—N (286.2 to 285.7 eV) and N═CN (287.9 to 287.4 eV) bonds were decreased with the appearance of the Co—C bond at 282.4 eV (FIG. 12a). The binding energy of the N═C—N bond of the triazine group also shifted to a lower energy (398.6 eV) in the N is spectrum of CoNP-PTCOF (FIG. 12b). The characteristic peaks of CoNPs appeared strongly in the Co 2 p spectrum of CoNP-PTCOF, whereas the peak of Cl anion almost disappeared (FIG. 12c and FIG. 13). Peak shifting of similar extent was also observed in the XPS spectrum of Co(NO₃)₂-coordinated PTCOF before annealing (FIG. 14), and the shift of XPS peaks of CoNP-PTCOF was confirmed to occur due to the binding between CoNPs and the framework. The shift of the binding energy of CoNP-PTCOF is caused by the electron transfer from the CoNPs to the framework and increases the electron density of the carbon backbone. The tuned electronic structure of CoNP-PTCOF will improve electrocatalytic activity for both ORR and OER.

3. Bifunctional CoNP-PTCOF Oxygen Electrocatalyst

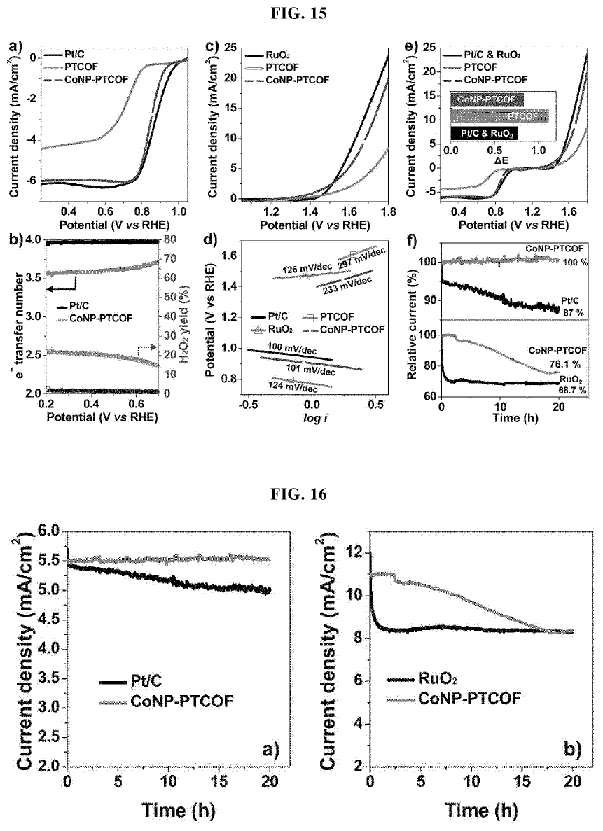

The electrocatalytic activity of CoNP-PTCOF for ORR and OER was measured at room temperature in an O₂-saturated KOH solution (0.1 M) using a three-electrode system equipped with a rotating disk electrode (RDE). For comparison, commercial Pt/C, RuO₂ NP and PTCOF were also investigated. As can be seen from the linear sweep voltammetry (LSV) curve for ORR (FIG. 15a), the half-wave potential (E_{1/2}) of CoNP-PTCOF was 0.85 V (vs RHE) at the diffusion-limited current density of −6.0 mA cm⁻², which was similar to that of commercial Pt/C (E_{1/2}=0.87 eV). In addition, the electrocatalytic activity of CoNP-PTCOF for ORR was improved greatly due to the tuning of the electronic structure of the framework as compared to that of PTCOF. The average number of electrons transferred during ORR catalyzed by CoNP-PTCOF was measured to be 3.62 in the range of 0.2-0.8V (vs RHE) with a hydrogen peroxide yield of 186% using a rotating ring-disk electrode (FIG. 15b). This suggests that the four-electron transfer pathway is dominant in the ORR catalyzed by CoNP-PTCOF as observed in Pt/C (number of transferred electrons=3.97).

Then, the electrocatalytic activity of CoNP-PTCOF for OER was investigated at room temperature in an O₂-saturated KOH solution (0.1 M) (FIG. 15c). CoNP-PTCOF showed overpotential of 0.45 V (vs RHE) at 10 mA cm⁻² (Eⱼ₁₀), similarly to that of commercial RuO₂ (0.4 V). In addition, the Eⱼ₁₀ value of CoNP-PTCOF was much lower than that of PTCOF (Eⱼ₁₀=0.6 V) (FIG. 15c), indicating that the electrocatalytic activity of CoNP-PTCOF for OER was improved greatly after the tuning of the electronic structure of the framework. The result of oxygen redox reaction clearly showed that CoNP-PTCOF exhibits bifunctional electrocatalytic activity for both ORR and OER.

The electron transfer kinetics of CoNP-PTCOF were investigated by drawing Tafel plots for ORR and OER. As shown in FIG. 15d, the Tafel slope of CoNP-PTCOF for ORR was 101 mV dec⁻¹, similar to that of commercial Pt/C (100 mV dec⁻¹). CoNP-PTCOF showed fast reaction kinetics for ORR than pristine PTCOF. In addition, the Tafel slope of CoNP-PTCOF for OER was much smaller than that of PTCOF (297 mV dec⁻¹) as 233 mV dec⁻¹, although it was larger than that of commercial RuO₂. The enhanced reaction rate of CoNP-PTCOF may be due to the tuned electronic structure that facilitates the adsorption and desorption of oxygen and its intermediates on active sites during the reaction.

The reversibility of oxygen redox reactions catalyzed by CoNP-PTCOF was evaluated by calculating the potential gap (E_{1/2}-Eⱼ₁₀) between the half-wave potential and the potential at 10 mA cm⁻². As shown in FIG. 15e, the bifunctional CoNP-PTCOF exhibited a voltage gap of 0.83 V, smaller than that of PTCOF (1.12 V). Although Pt/C & RuO₂ did not show bifunctionality for ORR and OER, the potential gap of a mixture of the two catalysts was 0.78 V. These results suggest that CoNP-PTCOF exhibits superior bifunctional electrocatalytic activity for the reversible oxygen redox reactions. In addition, CoNP-PTCOF showed superior durability for ORR and OER as compared to commercial Pt/C & RuO₂ (FIG. 15f and FIG. 16).

4. Performance of Rechargeable Zinc-Air B attery

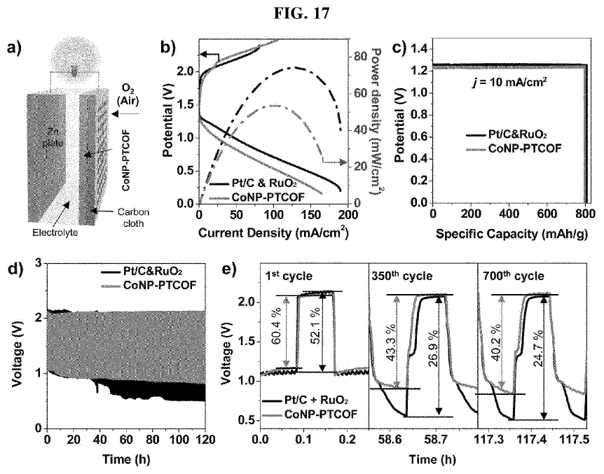

A rechargeable zinc-air battery was assembled with an air negative electrode made by drop-casting the bifunctional CoNP-PTCOF on a porous carbon cloth and a zinc plate positive electrode (FIG. 17a). A zinc-air battery for comparison was prepared by using a monofunctional mixture of Pt/C and RuO₂ as a negative electrode. The performance of the zinc-air batteries was measured in a 6 M KOH electrolyte containing 0.2 M Zn(OAc)₂ under air flow. The zinc-air battery with CoNP-PTCOF displayed a charge-discharge profile with a peak power density of 53 mW cm⁻², which was comparable to the battery with the mixture of Pt/C and RuO₂ (72.2 mW cm⁻² ) (FIG. 17b). The zinc-air battery with the bifunctional CoNP-PTCOF had a specific capacity of 796.9 mAh g⁻¹ at 10 mA cm⁻², which is very similar to that for the battery using the mixture of Pt/C and RuO² (808.2 mAh g⁻¹)

Finally, the durability of the rechargeable zinc-air battery assembled with CoNP-PTCOF was measured based on a 10 minute-cycle of continuous galvanostatic charge-discharge for 120 hours (FIG. 17d). The zinc-air battery with the bifunctional CoNP-PTCOF showed slight broadening in the continuous charge-discharge profile, while the battery with the mixture of commercial Pt/C and RuO₂ displayed large broadening in the voltage gap. As shown in FIG. 17e, the zinc-air battery with CoNP-PTCOF showed superior voltaic efficiency (60.4%) as compared to the battery with the mixture of Pt/C and RuO₂ (52.1%). The voltaic efficiency of the zinc-air battery with CoNP-PTCOF decreased a little bit to 40.2% in the 700th cycle. However, the decrease was much smaller than that observed for the battery with the mixture of Pt/C and RuO₂ (24.7%). These results show that the bifunctional zinc-air battery assembled with CoNP-PTCOF displays superior durability as compared to the battery with commercial Pt/C and RuO₂.

In the above-described example, pyridine-rich PTCOF with well-defined active sites and pores was readily prepared under mild conditions, and its electronic structure was effectively modulated by CoNP-PTCOF. The CoNP-PTCOF exhibited superior bifunctional electrocatalytic activity for both ORR and OER under alkaline conditions. The bifunctional zinc-air battery assembled with CoNP-PTCOF showed superior performance with a smaller voltage gap and excellent durability as compared to the battery using the mixture of commercial Pt/C and RuO₂. This strategy of designing a bifunctional COF electrocatalyst with well-defined active sites and tuning its electronic structure can be extended for fabrication of various carbon-based electrocatalysts in the field of energy storage and conversion.

1. An electrocatalyst for a metal-air battery comprising an organic framework coordinated with metal nanoparticles,
wherein the organic framework is formed by a substitution reaction of a first compound containing an amine group and a second compound containing a heterocycle substituted with a halogen group.

2. The electrocatalyst for a metal-air battery of claim 1, wherein the substitution reaction is a nucleophilic substitution reaction of the hydrogen of the amine group of the first compound and the halogen group of the second compound and, as a result, the first compound and the second compound are repeated in the organic framework.

3. The electrocatalyst for a metal-air battery of claim 1, wherein the metal nanoparticles are one or more selected from a group consisting of cobalt nanoparticles, iron nanoparticles, nickel nanoparticles and manganese nanoparticles.

4. The electrocatalyst for a metal-air battery of claim 1, wherein the first compound is one or more selected from a group consisting of 2,6-diaminopyridine, 2,5-diaminopyridine, imidazole, 2-methylimidazole, ethylenediamine and phenylenediamine.

5. The electrocatalyst for a metal-air battery of claim 1, wherein the halogen group is one or more selected from a group consisting of chloride, bromide and iodide.

6. The electrocatalyst for a metal-air battery of claim 1, wherein the heterocycle is one or more selected from a group consisting of triazine, pyridine and pyrimidine.

7. The electrocatalyst for a metal-air battery of claim 1, wherein the second compound is cyanuric chloride.

8. The electrocatalyst for a metal-air battery of claim 1, wherein the framework has a triangular form comprising pores of 0.5-20 nm and has a surface area of 100-500 m²/g.

9. The electrocatalyst for a metal-air battery of claim 1, wherein the framework has a structure of Chemical Formula 1:

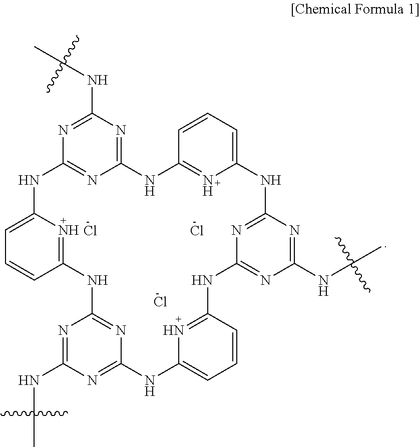 [SMILES: *Nc1nc2nc(n1)[nH]c1cccc(n1)[nH]c1nc(N*)nc(n1)[nH]c1cccc(n1)[nH]c1nc(N*)nc(n1)[nH]c1cccc(n1)[nH]2 ; Cl ; Cl ; Cl]

10. The electrocatalyst for a metal-air battery of claim 1, wherein the electrocatalyst has catalytic activity for oxygen reduction reaction (ORR) and oxygen evolution reaction (OER).

11. The electrocatalyst for a metal-air battery of claim 1, wherein the metal-air battery is a zinc-air battery.

12. A metal-air battery comprising the electrocatalyst of claim 1.

13. A method for preparing an electrocatalyst for a metal-air battery, comprising:
preparing an organic framework by a substitution reaction of a first compound containing an amine group and a second compound containing a heterocycle substituted with a halogen group; and
reacting the organic framework with a metal precursor.

14. The method for preparing an electrocatalyst for a metal-air battery of claim 13, wherein the substitution reaction is a nucleophilic substitution reaction of the hydrogen of the amine group of the first compound and the halogen group of the second compound and, as a result, the first compound and the second compound are repeated in the organic framework.

15. The method for preparing an electrocatalyst for a metal-air battery of claim 13, wherein the metal precursor is one or more selected from a group consisting of cobalt nitrate, cobalt sulfate, cobalt phosphate, cobalt tetrafluoroborate and cobalt chloride.

16. The method for preparing an electrocatalyst for a metal-air battery of claim 13, wherein the first compound is one or more selected from a group consisting of 2,6-diaminopyridine, 2,5-diaminopyridine, imidazole, 2-methylimidazole, ethylenediamine and phenylenediamine.

17. The method for preparing an electrocatalyst for a metal-air battery of claim 13, wherein the halogen group is one or more selected from a group consisting of chloride, bromide and iodide.

18. The method for preparing an electrocatalyst for a metal-air battery of claim 13, wherein the heterocycle is one or more selected from a group consisting of triazine, pyridine and pyrimidine.

19. The method for preparing an electrocatalyst for a metal-air battery of claim 13, wherein the second compound is cyanuric chloride.

20. The method for preparing an electrocatalyst for a metal-air battery of claim 13, wherein, in the preparing, the first compound and the second compound are mixed and reacted at 60-120° C. for 12-36 hours under stirring.

21-22. (canceled)
